(19) United States
(12) Patent Application Publication
(10) Pub. No.: US 2007/0253331 A1
(43) Pub. Date: Nov. 1, 2007

(54) Communications system, apparatus and method of communicating sub-channel data

(76) Inventors: Slawomir K. Ilnicki, Los Altos Hills, CA (US); Martin Curran-Gray, Dunfermline (GB)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/412,587

(22) Filed: Apr. 27, 2006

(51) Int. Cl. H04J 3/14; H04L 12/54

(52) U.S. Cl. 370/228; 370/428

(57) ABSTRACT

A communications system comprises a first network node coupled to a second network node so as to support a first main channel and a second main channel. A communications apparatus is coupled in-line between the first and second network nodes to support a first sub-channel in the first main channel and second sub-channel in the second main channel. The communications apparatus is arranged to determine whether an alternative sub-channel to the first sub-channel is required. If required, the communications apparatus selects the second sub-channel as the alternative sub-channel for communicating the sub-channel data.

The present invention relates to a communications apparatus of the type, for example, that is capable of creating a sub-channel for communicating sub-channel data in a main channel supported between a first network node and a second network node. The present invention also relates to a communications system of the type, for example, comprising a first network node and a second network node capable of supporting a main channel therebetween and a sub-channel within the main channel for carrying sub-channel data. The present invention further relates to a method of creating a sub-channel of the type, for example, in a main channel for carrying sub-channel data and supported between a first network node and a second network node.

### BACKGROUND ART

In the field of network communications, it is known to implement passive measurement techniques at selected points in a communications network in order to monitor Quality of Service levels and diagnose faults that can occur from time-to-time in the communications network.

In this respect, it is known to deploy so-called “passive probes” at the selected points in the communications network. Such passive probes make measurements relating to network traffic travelling along one or more links in the communications network. Additionally, once collected, measurement data has to be communicated to, for example, a central monitoring station in the communications network for analysis and interpretation.

In order to convey the measurement data from a passive probe to the central monitoring station, US 2005/0083957 A1 proposes a low bandwidth channel formed by inserting packets into a high bandwidth packet stream. The packets are inserted at a predetermined interval, insertion causing latency that is recovered by minimising inter-packet gaps in the incoming high bandwidth channel. While the packets to be inserted are being transmitted, arriving high bandwidth packets are stored in an elastic buffer.

However, whilst the above technique provides a mechanism for achieving the low bandwidth channel in the high bandwidth packet stream, it is desirable to improve performance of the low bandwidth channel. In particular, the above-described technique relies upon the existence of sufficiently large “gaps” in the high bandwidth data stream that can be reduced to allocate bandwidth to accommodate transmission time for the low bandwidth channel. However, the above apparatus preserves traffic flow in the high bandwidth data stream as the traffic in the high bandwidth data stream is considered to be of greater importance than the traffic using the low bandwidth channel. This is an overriding principle to which operation of the above apparatus adheres. Hence, if insufficient gaps exist in the high bandwidth data stream, transmissions on the low bandwidth channel have to be halted due to lack of bandwidth until a sufficiently large gap occurs in the high bandwidth stream.

As a result of a temporary incapability to transmit on the low bandwidth channel, it is necessary to buffer the measurement data to be transmitted until the measurement data can be transmitted. Whilst the apparatus described above comprises the elastic buffer, there is a limit to elasticity of the buffer and provision of a larger buffer has cost implications. To avoid running out of buffer capacity, the apparatus reaches a point where creation of new packets has to be temporarily halted until bandwidth becomes available to resume transmission of the measurement data. Alternatively, the apparatus discards packets already created (and in the buffer) in order to provide capacity in the buffer for newly created packets containing measurement data.

### SUMMARY OF THE DISCLOSED EMBODIMENTS

According to a first aspect of the present invention, there is provided a communications system comprising: a first network node and a second network node, the first and second network nodes being capable of supporting a first main channel and a second main channel therebetween; and an apparatus for creating a first sub-channel in the first main channel and a second sub-channel in the second main channel, the apparatus comprising: a data store for temporarily storing sub-channel data; a processing resource for monitoring communication in a first direction on the first main channel and communication in a second direction on the second main channel, the processing resource being arranged to attempt to identify a first suitable channel condition for supporting the first sub-channel in the first direction in the first main channel, and to identify a second suitable channel condition for supporting the second sub-channel in the second direction in the second main channel; and the processing resource is further arranged to select to transmit the sub-channel data on the second sub-channel in response to the processing resource being unable to identify the first suitable channel condition.

The attempt to identify the second suitable channel condition may be made in response to insufficient time being available to the processing resource to identify the first suitable channel condition.

The processing resource may be arranged to determine whether the insufficient time is available to the processing resource to await probabilistic occurrence of the first suitable channel condition.

The processing resource may be capable of sending the sub-channel data to a third network node for receiving the sub-channel data, and may be arranged to send the sub-channel data to a fourth network node in response to identification of the second suitable channel condition.

The fourth network node may be arranged to communicate the sub-channel data to the third network node.

Support of the first sub-channel may be support of initiation of transmission of the sub-channel data in place of at least part of first data for signifying a first idle period in the communication in the first direction, and support of the second sub-channel may be support of initiation of transmission of the sub-channel data in place of at least part of second data for signifying a second idle period in the communication in the second direction.

According to a second aspect of the present invention, there is provided an apparatus for communicating sub-channel data in a first sub-channel or a second sub-channel within a first main channel or a second main channel respectively, the first and second main channels being between a first network node and a second network node; the apparatus comprising: a data store for temporarily storing the sub-channel data; a processing resource for monitoring communication in a first direction on the first main channel and communication in a second direction on the second main channel, the processing resource being arranged to attempt to identify a first suitable channel condition for supporting the first sub-channel in the first direction in the first main channel, and to identify a second suitable channel condition for supporting the second sub-channel in the second direction in the second main channel; and the processing resource is further arranged to select to transmit the sub-channel data on the second sub-channel in response to the processing resource being unable to identify the first suitable channel condition.

The attempt to identify the second suitable channel condition may be made in response to insufficient time being available to the processing resource to identify the first suitable channel condition.

The processing resource may be arranged to determine whether the insufficient time is available to the processing resource to await probabilistic occurrence of the first suitable channel condition.

The processing resource may be capable of addressing the sub-channel data to a first destination address, and arranged to address the sub-channel data to a second destination address in response to identification of the second suitable channel condition.

The first destination address may correspond to a third network node accessible via the first direction and the second destination address may correspond to a fourth network node alternatively accessible via the second direction.

Support of the first sub-channel may be support of initiation of transmission of the sub-channel data in place of at least part of first data for signifying a first idle period in the communication in the first direction, and support of the second sub-channel may be support of initiation of transmission of the sub-channel data in place of at least part of second data for signifying a second idle period in the communication in the second direction.

According to a third aspect of the present invention, there is provided a method of communicating sub-channel data, the method comprising: supporting a first sub-channel within a first main channel and a second sub-channel within a second main channel, the first and second main channels being supported between a first network node and a second network node; temporarily storing the sub-channel data; monitoring communications in a first direction on the first main channel; attempting to identify a first suitable channel condition for supporting the first sub-channel in the first direction in the first main channel; monitoring communications in a second direction on the second main channel; identifying a second suitable channel condition for supporting the second sub-channel in the second main channel in the second direction; and selecting to transmit the sub-channel data in the second sub-channel in response to the processing resource being unable to identify the first suitable channel condition.

According to a fourth aspect of the present invention, there is provided a computer program element comprising computer program code means to make a computer execute the method as set forth above in relation to the third aspect of the invention.

The computer program code element may be embodied on a computer readable medium.

It is thus possible to provide a system, apparatus and method therefor that are capable of ensuring transmission of sub-channel data when an initially selected sub-channel lacks capacity and capacity cannot be awaited; for example due to a constraint, such as a buffer size. Data loss in relation to the sub-channel can therefore be obviated or at least mitigated. Also, it is possible to send, with minimal delay, high priority data, such as an alarm message, without having to wait for sufficiently large gaps in a datastream in one direction between network nodes. Additionally, sub-channel data loading is balanced so that a lack of capacity on a given main channel is avoided.

### BRIEF DESCRIPTION OF DRAWINGS

At least one embodiment of the invention will now be described, by way of example only, with reference to the accompanying drawings, in which:

FIG. 1 is a schematic diagram of a communications system comprising a communications apparatus constituting an embodiment of the invention;

FIG. 2 is a schematic diagram of the communications apparatus of FIG. 1 in greater detail; and

FIG. 3 is a flow diagram of a method employed by the communications apparatus of FIG. 1 and FIG. 2.

### DETAILED DESCRIPTION

Throughout the following description identical reference numerals will be used to identify like parts.

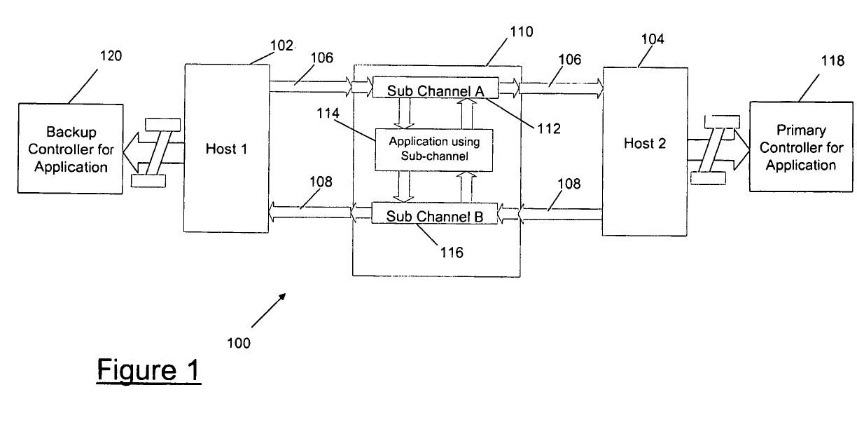

Referring to FIG. 1, a communications system 100 comprises a first network node, for example a first host 102 capable of communicating with a second network node, for example a second host 104. The first host 102 is therefore coupled to the second host 104 by a first unidirectional communications link 106 in a first direction and a second unidirectional communications link 108 in a second direction opposite to the first direction, thereby providing communications media for bi-directional communications between the first and second hosts 102, 104. In this example, the first host 102 is a first router and the second host 104 is a second router, the first and second routers together providing connectivity between domains (not shown) in a communications network (also not shown). However, the skilled person will appreciate that the first and second hosts 102, 104 can be other functional pairs of communications elements, for example an Ethernet card in a Personal Computer and a router, respectively.

The first and second unidirectional communications links 106, 108 are each supported, in this example, by a respective optical fibre. A first main communications channel is supported by the first unidirectional communications link 106 and a second main communications channel is supported by the second unidirectional communications link 108.

In order to support a first sub-channel in the first main channel, and a second sub-channel in the second main channel, an in-line sub-channel apparatus 110 of the type described in EP-A1-1 524 807 is disposed in the first and second communications links 106, 108 between the first and second hosts 102, 104. Although the structure and operation of the in-line sub-channel apparatus 110 is well-documented in EP-A1-1 524 807, for the sake of ease of reference and ready understanding of the additional and/or alternative functionality described later herein, the structure of the in-line sub-channel apparatus 110 will now be briefly described.

The in-line sub-channel apparatus 110 comprises a first sub-channel injector 112 coupled to an application logic 114 that uses the first sub-channel supported by the first sub-channel injector 112. The application logic 114 serves as a processing resource. In contrast with EP-A1-1 524 807, the in-line sub-channel apparatus 110 also comprises a second sub-channel injector 116 coupled to the application logic 114 as the application logic 114 also uses, in this example, the second sub-channel supported by the second sub-channel injector 116. Since the second sub-channel injector 116 is a reverse-direction implementation of the first sub-channel injector 112, the second sub-channel injector 116 will not be described in further detail herein, since the skilled person will appreciate the structure and function of the second sub-channel injector 116 from a description of the first sub-channel injector 112.

A primary node 118 is located within the communications network so as to be accessible via the second host 104. A backup node 120 is located within the communications network so as to be accessible via the first host 102.

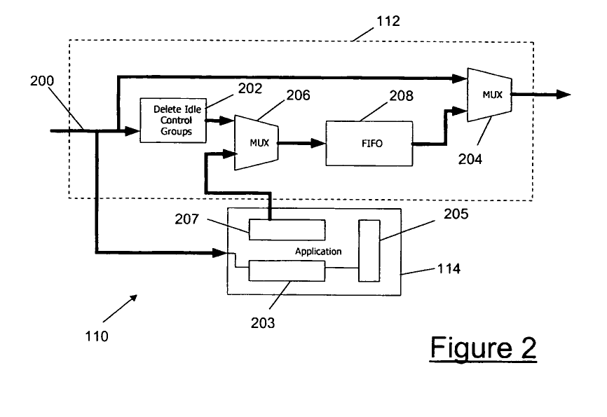

Turning to FIG. 2, the application logic 114 supports a monitor module 203 capable of communicating with a load balancer module 205. The monitor module 203 is coupled to a datastream input 200 of the first sub-channel injector 112. The datastream input 200 is also coupled to an input of an idle deletion module 202 and a first input of a first multiplexer 204. An output of the idle deletion module 202 is coupled to a first input of a second multiplexer 206, a second input of the second multiplexer 206 being coupled to an internal buffer 207 of the application logic 114. An output of the second multiplexer 206 is coupled to an input of a First-In-First-Out (FIFO) buffer 208, an output of the FIFO buffer 208 being coupled to a second input of the first multiplexer 204.

Although not shown and not required if data is to be processed in serial, a de-serialiser module is coupled before the datastream input 200 to perform a serial-to-parallel conversion on incoming data arriving at the first sub-channel injector 112 and a serialiser module is coupled to an output of the first multiplexer 204 to perform a parallel-to-serial conversion on outgoing data leaving the first sub-channel injector 112.

In operation, the communications system 100 supports a Gigabit Ethernet protocol in accordance with the Institute of Electrical and Electronic Engineers (IEEE) standard 802.3 and the in-line sub-channel apparatus 110 is capable of functioning in a manner described in EP-A1-1 524 807. However, the skilled person will recognise that the functionality of the in-line sub-channel apparatus 110 can be modified to include only some of the functionality described in EP-A1-1 524 807. Likewise, in the present example, the functionality of the in-line sub-channel apparatus 110 has been enhanced and support for the second sub-channel injector 116 is described herein.

In this example, the in-line sub-channel apparatus 110 is part of a communications monitoring apparatus (not shown), for example a probe, such as any suitable probe for measuring network performance, that generates measurement data in relation to given communications links, for example the first unidirectional communications link 106 and the second unidirectional communications link 108. Typically, the sub-channel is supported by the in-line sub-channel apparatus 110 to communicate the measurement data generated to a central monitoring station for analysis in order to monitor Quality of Service, inter alia, in the communications system 100 and diagnose any faults.

When the first host 102 does not need to communicate with the second host 104, the first host 102, instead of simply remaining inactive during an idle period, sends data signifying the idle period in the datastream to the second host 104. As described in EP-A1-1 524 807, the in-line sub-channel apparatus 110 exploits idle periods on the first main channel to support the first sub-channel. In an analogous manner, the in-line sub-channel apparatus 110 also exploits idle periods on the second main channel to support the second sub-channel.

The bi-directional nature of the in-line sub-channel apparatus 110 can be exploited to perform load balancing with respect to the first and second sub-channels to attempt to avoid excessive loading of a given one of the first and second sub-channels and hence a given one of the first and second main channels. Additionally, an alternative router, constituting the backup node 120, is made available to send the sub-channel data when the first sub-channel is congested and lacks capacity to carry sub-channel data.

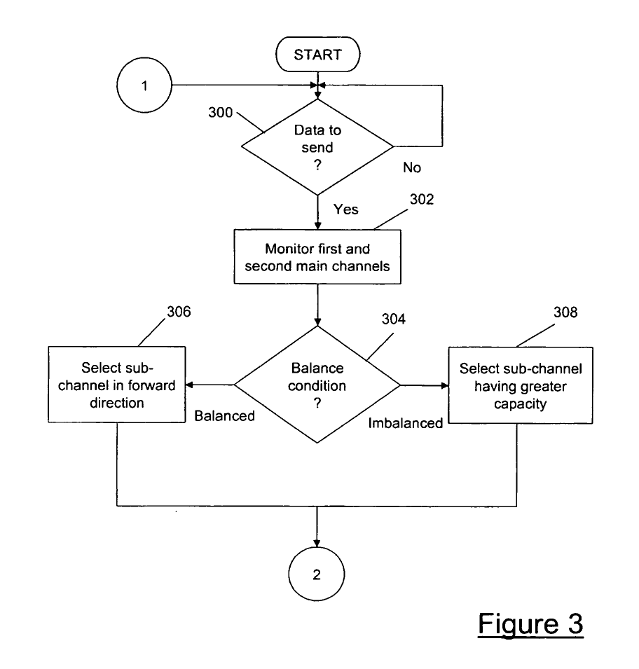

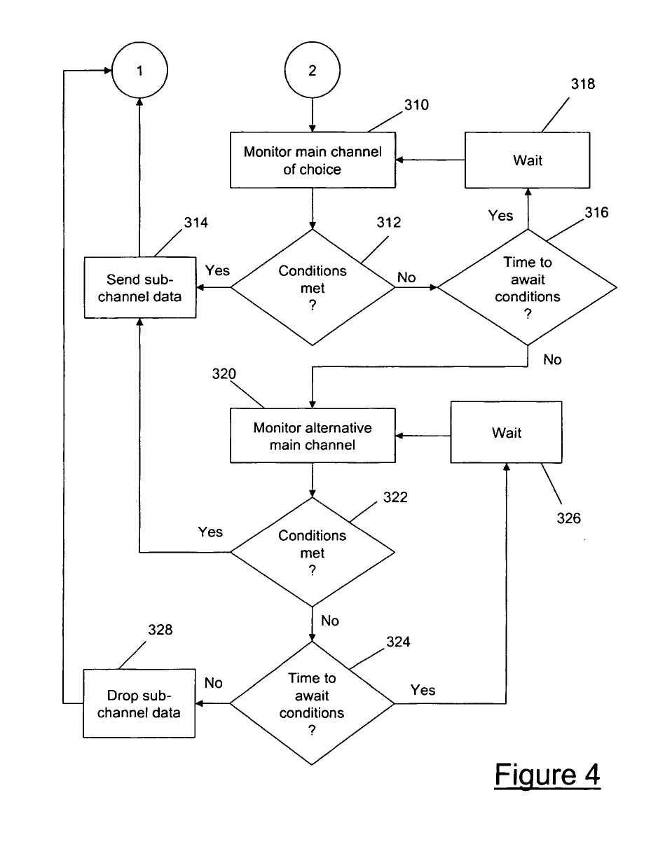

Referring to FIG. 3, in order to perform load balancing of the first and second sub-channels and/or avoid congested sub-channels, the application logic 114 determines (300) whether the internal buffer 207 contains sub-channel data to be transmitted to the primary node 118, for example measurement data to be sent to the primary node 118 constituting the central monitoring station. If no sub-channel data needs to be sent, the application logic 114 simply periodically monitors the status of the internal buffer 207 and in accordance with a by-pass mode, incoming frames of data received by the in-line sub-channel apparatus 110 are passed to the first multiplexer 204 without further interference, and hence delay, caused by the application logic 114, whereupon output frames, constituting unmodified versions of the incoming frames of data, are sent by the in-line sub-channel apparatus 110 for receipt by the second host 104.

In contrast, if the internal buffer 207 contains sub-channel data to be sent, the monitoring module 203 of the application logic 114 monitors (302) the first main channel and the second main channel and the load balance module 205 of the application logic 114 determines (304) whether traffic loading of the first and second main channels is in balance.

If the first and second main channels are in balance, the load balance module 205 of the application logic 114 selects (306), by default, the first sub-channel, in a forward direction towards the primary node 118, for sending the sub-channel data to the primary node 118. Alternatively, if traffic on the first and second main channels is not balanced, the load balance module 205 selects (308) whichever of the first and second sub-channels that corresponds with whichever of the first and second main channel that has most capacity available.

Once one of the first and second sub-channels has been selected for carrying the sub-channel data, the monitor module 203 of the application logic 114 monitors (310) whichever of the first and second main channels that corresponds to the selected sub-channel.

The application logic 114 then determines (312) whether conditions on the main channel corresponding to the selected sub-channel (hereinafter referred to as the “selected main channel”) are suitable to support initiation of transmission of at least one packet being stored by the internal buffer 207. Consequently, first data signifying the idle period must be detected on the selected main channel and, for example, occurrences of idle periods on the selected main channel may not be of sufficient length to support initiation of transmission of at least part of the sub-channel data, i.e. data stored by the internal buffer 207. Another condition that may need to be met (depending upon system requirements) is whether a so-called “hold timer”, as described in EP-A1-1 524 807, has expired. Additionally or alternatively, the condition can be whether a detected idle period exceeds a calculated average duration. In this example, for the sake of simplicity of description, the application logic 114 only verifies if a detected idle period, identified by data codes conforming to the IEEE 802.3 standard, is greater than a predetermined minimum suitable duration.

If the idle period is greater than the predetermined minimum suitable duration, the in-line sub-channel apparatus 110 sends (314) the at least part of the sub-channel data in accordance with the technique described in EP-A1-1 524 807, and depending upon the capacity of the FIFO buffer 208, using the selected sub-channel. On the other hand, if the conditions on the main channel are not suitable, for example the above minimum duration condition has not been met, the application logic 114 determines (316) whether waiting a first predetermined delay period is permissible, for example without resulting in overflow of the internal buffer 207. The occurrence of the suitable channel condition is, of course, probabilistic. However, if it is possible to wait the first predetermined delay period, the application logic 114 abstains (318) from sending the at least part of the sub-channel data for the predetermined delay period and then reverts to monitoring the selected main channel (310) and determining (312) whether the conditions on the selected main channel are now suitable for implementing the sub-channel.

If the applications logic 114 determines that the first predetermined delay period cannot be awaited because, for example, the internal buffer 207 will overflow, the monitoring module 203 of the application logic 114 monitors (320) the remaining, unselected, main channel in order to determine if the unselected main channel has capacity to support the other, unselected, sub-channel.

Consequently, in an analogous manner to that already described above in relation to the selected main channel, the application logic 114 determines (322) whether conditions on the main unselected channel are suitable to support initiation of transmission of at least one packet being stored by the internal buffer 207. Consequently, second data signifying the idle period must be detected on the unselected main channel and, for example, occurrences of idle periods on the unselected main channel may not be of sufficient length to support initiation of transmission of at least part of the sub-channel data, i.e. data stored by the internal buffer 207. Another condition that may need to be met (depending upon system requirements) is whether a so-called “hold timer”, as described in EP-A1-1 524 807, has expired. Additionally or alternatively, the condition can be whether a detected idle period exceeds a calculated average duration. In this example, for the sake of simplicity of description, the application logic 114 only verifies if a detected idle period, identified by data codes conforming to the IEEE 802.3 standard, is greater than a predetermined minimum suitable duration.

If the idle period is greater than the predetermined minimum suitable duration, the in-line sub-channel apparatus 110 sends (314) the at least part of the sub-channel data in accordance with the technique described in EP-A1-1 524 807, and depending upon the capacity of the FIFO buffer 208, using the unselected sub-channel. On the other hand, if the conditions on the main channel are not suitable, for example the above minimum duration condition has not been met, the application logic 114 determines (324) whether waiting a second predetermined delay period is permissible, for example without resulting in overflow of the internal buffer 207. The occurrence of the suitable channel condition is, of course, probabilistic. However, if it is possible to wait the second predetermined delay period, the application logic 114 abstains (326) from sending the at least part of the sub-channel data for the predetermined delay period and then reverts monitoring the unselected main channel (320) and to determining (322) whether the conditions on the main channel are now suitable for implementing the sub-channel.

Alternatively, if the application logic 114 determines that the second predetermined delay cannot be awaited in respect of the unselected sub-channel because, for example, the internal buffer 207 will overflow, the application logic 114, in this example, decides to drop one or more packet from the internal buffer 207. Of course, as an alternative measure, the application logic can cease to generate data, and hence fill the internal buffer 207.

Where the second sub-channel is being employed, the sub-channel data is addressed to the backup node 120, and upon receipt of the sub-channel data by the backup node 120, the backup node 120 forwards the received sub-channel data to the primary node 118.

Although the above examples have been described in the context of packet communications, it should be appreciated that the term “message” is intended to the construed as embracing packets, datagrams, frames, cells and/or protocol data units and so these terms should be understood to be interchangeable. Therefore, in the context as described herein, it should be understood that a “packet” is not just an IP packet but it is a frame that can contain an IP packet. In the case of Ethernet, it is an Ethernet frame that may already be encoded, for example using 8B/10B encoding. The type of encoding will depend on encoding techniques used by passing traffic on the main channel.

Whilst it has been suggested above that the in-line sub-channel apparatus is implemented in a probe, the skilled person will appreciate that the in-line sub-channel apparatus can be implemented in various forms, for example in a highly integrated form suitable for replacing industry-standard interface converter modules, for example those known as GigaBit Interface Converters (GBICs). Current GBICs are effectively transceivers that translate signals of one media type, for example optical or electrical, to another media type. By providing a replacement GBIC including the in-line sub-channel apparatus, numerous applications requiring sub-channels are further enabled.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example, microwave or infrared. The series of computer instructions can constitute all or part of the functionality described above, and can also be stored in any memory device, volatile or non-volatile, such as semiconductor, magnetic, optical or other memory device.

What is claimed is:

1. A communications system comprising:
a first network node and a second network node, the first and second network nodes being capable of supporting a first main channel and a second main channel therebetween; and
an apparatus for supporting a first sub-channel in the first main channel and a second sub-channel in the second main channel, the apparatus comprising:
a data store for temporarily storing sub-channel data;
a processing resource for monitoring communication in a first direction on the first main channel and communication in a second direction on the second main channel; wherein
the processing resource is arranged to determine whether an alternative sub-channel to the first sub-channel is required for communicating the sub-channel data, and to select the second sub-channel as the alternative sub-channel to the first sub-channel for communicating the sub-channel data in the second direction as opposed to the first direction.

2. A system as claimed in claim 1, wherein the processing resource is arranged to attempt to identify a first suitable channel condition for supporting the first sub-channel in the first direction in the first main channel, and to identify a second suitable channel condition for supporting the second sub-channel in the second direction in the second main channel; and
the processing resource is further arranged to select to transmit the sub-channel data on the second sub-channel in response to the processing resource being unable to identify the first suitable channel condition.

3. A system as claimed in claim 2, wherein the attempt to identify the second suitable channel condition is made in response to insufficient time being available to the processing resource to identify the first suitable channel condition.

4. A system as claimed in claim 3, wherein the processing resource is arranged to determine whether or not the insufficient time is available to the processing resource to await probabilistic occurrence of the first suitable channel condition.

5. A system as claimed in claim 1, wherein the second sub-channel is selected as the alternative sub-channel to the first sub-channel in order to balance loading between the first and second main channels.

6. A system as claimed in claim 1, wherein the processing resource is capable of sending the sub-channel data to a third network node for receiving the sub-channel data, and arranged to send the sub-channel data to a fourth network node in response to identification of the second suitable channel condition.

7. A system as claimed in claim 6, wherein the fourth network node is arranged to communicate the sub-channel data to the third network node.

8. A system as claimed in claim 2, wherein supporting the first sub-channel is supporting initiation of transmission of the sub-channel data in place of at least part of first data for signifying a first idle period in the communication in the first direction, and supporting the second sub-channel is supporting initiation of transmission of the sub-channel data in place of at least part of second data for signifying a second idle period in the communication in the second direction.

9. An apparatus for communicating sub-channel data, the apparatus comprising:
a data store for temporarily storing the sub-channel data;
a first sub-channel injector for supporting a first sub-channel within a first main channel between a first network node and a second network node;
a second sub-channel injector for supporting a second sub-channel within a second main channel between the first and second network nodes; and
a processing resource for monitoring communication in a first direction on the first main channel and communication in a second direction on the second main channel; wherein
the processing resource is arranged to determine whether an alternative sub-channel to the first sub-channel is required for communicating the sub-channel data, and to select the second sub-channel as the alternative sub-channel to the first sub-channel for communicating the sub-channel data in the second direction as opposed to the first direction.

10. An apparatus as claimed in claim 9, wherein the processing resource is arranged to attempt to identify a first suitable channel condition for supporting the first sub-channel in the first direction in the first main channel, and to identify a second suitable channel condition for supporting the second sub-channel in the second direction in the second main channel; and
the processing resource is further arranged to select to transmit the sub-channel data on the second sub-channel in response to the processing resource being unable to identify the first suitable channel condition.

11. An apparatus as claimed in claim 10, wherein the attempt to identify the second suitable channel condition is made in response to insufficient time being available to the processing resource to identify the first suitable channel condition.

12. An apparatus as claimed in claim 11, wherein the processing resource is arranged to determine whether the insufficient time is available to the processing resource to await probabilistic occurrence of the first suitable channel condition.

13. A system as claimed in claim 9, wherein the second sub-channel is selected as the alternative sub-channel to the first sub-channel for balancing loading between the first and second main channels.

14. An apparatus as claimed in claim 9, wherein the processing resource is capable of addressing the sub-channel data to a first destination address, and arranged to address the sub-channel data to a second destination address in response to identification of the second suitable channel condition.

15. An apparatus as claimed in claim 14, wherein the first destination address corresponds to a third network node accessible via the first direction and the second destination address corresponds to a fourth network node alternatively accessible via the second direction.

16. An apparatus as claimed in claim 10, wherein supporting the first sub-channel is supporting initiation of transmission of the sub-channel data in place of at least part of first data for signifying a first idle period in the communication in the first direction, and supporting the second sub-channel is supporting initiation of transmission of the sub-channel data in place of at least part of second data for signifying a second idle period in the communication in the second direction.

17. A method of communicating sub-channel data, the method comprising:
supporting a first sub-channel within a first main channel and a second sub-channel within a second main channel, the first and second main channels being supported between a first network node and a second network node;
temporarily storing the sub-channel data;
monitoring communication in a first direction on the first main channel and communication in a second direction on the second main channel;
determining whether an alternative sub-channel to the first sub-channel is required for communicating the sub-channel data; and
selecting the second sub-channel as the alternative sub-channel to the first sub-channel for communicating the sub-channel data in the second direction as opposed to the first direction.

18. A computer program element comprising computer program code means to make a computer execute the method of claim 17.

19. A computer program code element as claimed in claim 18, embodied on a computer readable medium.
